(19) United States
(12) Patent Application Publication
(10) Pub. No.: US 2004/0059624 A1
(43) Pub. Date: Mar. 25, 2004

(54) Systems and methods for analyzing customer surveys

(76) Inventors: John Wantulok, Boise, ID (US); Brad Teuscher, Eagle, ID (US); Heidi Wilfong, Boise, ID (US); Suzanne Cho, Valencia, CA (US)

Correspondence Address: HEWLETT-PACKARD COMPANY, Intellectual Property Administration, P.O. Box 272400, Fort Collins, CO, 80527-2400, US

(21) Appl. No.: 10/228,423

(22) Filed: Aug. 27, 2002

(51) Int. Cl. G06F 17/60

(52) U.S. Cl. 705/10

(57) ABSTRACT

Systems for analyzing customer surveys associated with Web sites are provided. One such customer analysis system is operative to determine whether a user of a Web site is to be provided with a customer survey and to generate identification information corresponding to the user. Thus, if the user is to be provided with a customer survey, the identification information is generated, and is enabled to be associated with the customer survey and information corresponding to a path through the Web site traversed by the user. Methods, computer-readable media and other systems also are provided.

### BACKGROUND OF THE INVENTION

11. Field of the Invention

The present invention generally relates to customer surveys and, in particular, to systems and methods that involve the use of customer surveys in association with Web sites.

2. Description of the Related Art

Many entities offer goods and/or services to customers via Web sites. As is known, customers may have difficulty finding information while navigating through various pages of such a Web site. Because of this, it is generally considered useful to gather comments pertaining to a customer's experiences with a Web site. Based upon such comments, an entity may consider modifying its Web site to make the site more customer-friendly, for example. Typically, gathering of customer comments is accomplished through the use of a customer survey.

Since the field of customer surveys is oftentimes considered a field in which specialized knowledge, e.g., marketing expertise, is required, many entities outsource work associated with developing and providing customer surveys. This may be the case even though the entity manages, e.g., provides content for, its Web site. Furthermore, many entities outsource the tracking of information, such as numbers of hits and customer click-paths (the paths traversed by customers using a Web site), to yet another entity.

Because information pertaining to various aspects of a customer's experience with a Web site can be acquired and/or maintained by various entities, it can be difficult to correlate the information so that meaningful analysis of the information can be accomplished. Therefore, there is a need for improved systems and methods that address these and/or other perceived shortcomings of the prior art.

### SUMMARY OF THE INVENTION

Briefly described, the present invention involves analyzing customer surveys associated with Web sites. In this regard, an embodiment of a system in accordance with the invention includes a customer analysis system that is operative to determine whether a user of a Web site is to be provided with a customer survey. If the user is to be provided with a customer survey, the customer analysis system generates identification information corresponding to the user, and enables the identification information to be associated with the customer survey as well as with information corresponding to a path through the Web site traversed by the user.

In some embodiments, a traffic-monitoring system is provided that communicates with the customer analysis system. The traffic-monitoring system is operative to determine the path through the Web site traversed by the user and receive the identification information. The traffic-monitoring system also associates the identification information with the path and communicates the path to the customer analysis system.

In some embodiments, a survey system is provided that communicates with the customer analysis system. The survey system is operative to provide the user with the customer survey, receive responses of the user to the customer survey, and receive the identification information. The survey system also associates the identification information with the responses and communicates the responses to the customer analysis system.

In some embodiments, a Web service system also is provided that communicates with the customer analysis system. The Web service system is operative to provide the Web site and determine whether the user is to be provided with a customer survey. If the customer is to be provided with a customer survey, the Web service system notifies the customer analysis system that the customer is to be provided with a customer survey.

Methods also are provided. In this regard, an embodiment of a method in accordance with the invention includes: determining whether a user of a Web site is to be provided with a customer survey; and, if the user is to be provided with a customer survey, generating identification information corresponding to the user, enabling the identification information to be associated with the customer survey, and enabling the identification information to be associated with information corresponding to a path through the Web site traversed by the user.

Another embodiment of a method in accordance with the invention includes: providing a Web site; determining whether a user of the Web site is to be provided with a customer survey; if the user is to be provided with a customer survey, generating identification information corresponding to the user, and enabling the identification information to be associated with the customer survey; acquiring information corresponding to a path through the Web site traversed by the user; associating the identification information with information corresponding to the path through the Web site traversed by the user; and using the identification information to correlate responses of the user to the customer survey with the information corresponding to the path through the Web site traversed by the user.

Computer-readable media are provided as well. In this regard, an embodiment of a computer-readable medium in accordance with the invention includes logic configured to determine whether a user of a Web site is to be provided with a customer survey, and logic configured to generate identification information corresponding to the user. Logic configured to associate the identification information with the customer survey, and logic configured to associate the identification information with information corresponding to a path through the Web site traversed by the user also are included.

Another embodiment of a computer-readable medium in accordance with the invention includes logic configured to receive information corresponding to a path through the Web site traversed by the user, and logic configured to receive responses of the user to the customer survey. Logic configured to provide a graphical representation of the responses correlated with the information corresponding to the path through the Web site traversed by the user also is included. This logic enables images corresponding to at least some of the Web pages of the Web site that the user traversed to be displayed together with at least some of the responses of the user.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting an embodiment of a Web-based survey system in accordance with the present invention.

FIG. 2 is a flowchart depicting functionality of the embodiment of FIG. 1.

FIG. 3 is a flowchart depicting functionality of another embodiment of the Web-based survey system in accordance with the invention.

FIG. 4 is a schematic diagram depicting a computer or processor-based device that can be used to implement customer analysis systems in accordance with the present invention.

FIG. 5 is a flowchart depicting functionality of the embodiment of the survey ID system of FIG. 4.

FIG. 6 is a flowchart depicting functionality of another embodiment of a survey ID system in accordance with the invention.

FIG. 7 is a flowchart depicting functionality of the embodiment of the post-customer analysis system of FIG. 4.

FIG. 8 is a representative screen shot depicting information that can be provided by the embodiment of the customer analysis system of FIG. 4.

FIG. 9 is another representative screen shot that can be provided by an alternative embodiment of a customer analysis system in accordance with the invention.

### DETAILED DESCRIPTION

As will be described in detail here, systems and methods in accordance with the invention are able to facilitate the use of customer surveys. In particular, these systems and methods can enable meaningful analysis of customer survey results. This can be accomplished even though various functions, e.g., providing a Web site, managing information pertaining to use of the Web site, developing customer surveys and/or acquiring customer survey results, may be performed by distinct entities.

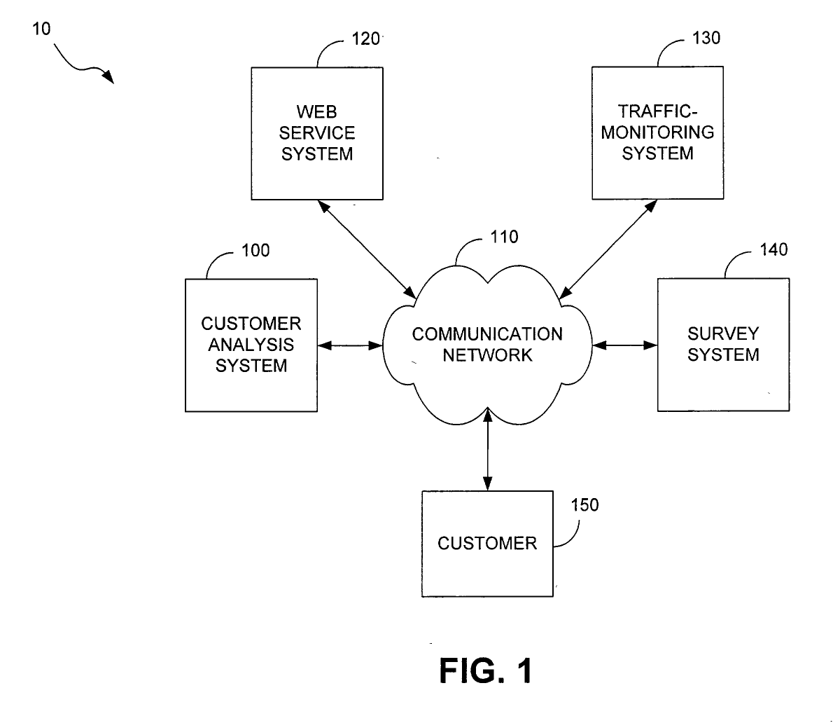

Referring now to the drawings, FIG. 1 is a schematic diagram that depicts an embodiment of a Web-based survey system in accordance with the present invention. As shown in FIG. 1, Web-based survey system 10 includes a customer analysis system 100 that communicates with a communication network 110. Communication network 110 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

Various other systems communicate with communication network 110. More specifically, Web service system 120, traffic-monitoring system 130 and survey system 140 communicate with the communication network and, thus, can communicate with the customer analysis system and/or with each other.

A customer 150 also is depicted in FIG. 1. Customer 150 communicates with the communication network such as via a personal computer, personal digital assistant (PDA) or other computing device.

Web service system 120 hosts Web pages of a Web site so that a customer can have access to the Web site, such as via the Internet. In particular, the Web service system receives substantive content for use in the various Web pages and provides customers with access to the content, i.e., the Web service system hosts the Web site.

Traffic-monitoring system 130 acquires information relating to the use of one or more Web sites. More specifically, traffic-monitoring system 130 can acquire information regarding the path (known as a “click-path) of Web pages traversed by a customer when using a Web site. The traffic-monitoring system also can acquire other information such as the date/time that a particular page was accessed, the manner in which a page was accessed, and the identification of a particular customer. Typically, such information is acquired through the use of cookies.

Survey system 140 provides customer surveys, i.e., one or more questions, to customers so that responses of a customer to a survey can be acquired. Surveys can be provided in various forms, such as via a customer requested survey that is displayed to a customer while using a Web site or an email that is sent to a customer at a time after the customer has completed using a Web site.

In some embodiments, the customer analysis system, Web service system, traffic-monitoring system, and survey system could be operated by the same entity. In such an embodiment, information pertaining to a customer, the customer's click-path and/or responses to a survey can be readily shared between the various systems. However, in other embodiments, at least two of the systems are operated by different entities. As will be described in greater detail below, when the systems are operated by different entities, one entity may desire to maintain information that it has acquired confidential.

By way of example, the entity associated with the traffic-monitoring system may have acquired information pertaining to a customer. The entity, however, may employ an information confidentiality procedure that prohibits customer information from being shared with another entity. Because of this, it may be difficult to correlate information acquired by entities associated with other systems depicted in FIG. 1. By way of further example, if information has been acquired by an entity via use of a cookie, another entity typically does not have access to the acquired information. More specifically, cookies enable information to be provided to the system that generated the cookie. Thus, only one party typically has access to the information associated with such a cookie.

Customer analysis systems in accordance with the invention can alleviate these difficulties as described below.

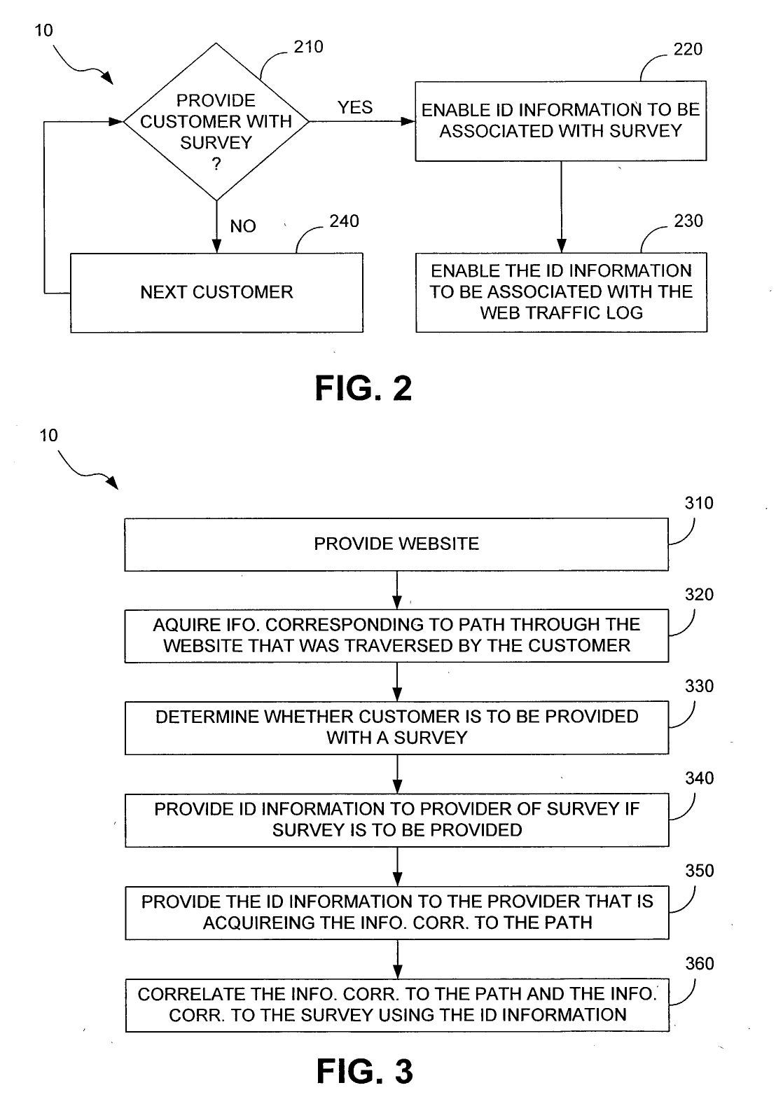

Functionality of the survey system 10 of FIG. 1 will now be described with respect to the flowchart-of FIG. 2. As shown in FIG. 2, the functionality (or method) 10 may be construed as beginning at block 210, where a determination is made as to whether a customer is to be provided with a survey. If it is determined in block 210 that the customer is to be provided with a survey, the process proceeds to block 220. In block 220, identification information is enabled to be associated with a survey, i.e., a survey that is to be provided to the customer. By way of example, the ID information can be in the form of an alpha-numeric designator that is provided by a customer analysis system. Thereafter, such as depicted in block 230, the ID information is enabled to be associated with information that corresponds to the customer's use of a Web site, e.g., a Web traffic log. If, however, it was determined that the customer is not to be provided with a survey (block 210), the process may proceed to block 240. In block 240, a “next” customer is identified. The process then can return to block 210 and proceed as described before.

Once it has been determined that a customer is to be provided with a survey, the survey system can provide that customer with a pop-up window that includes a customer survey initiation form that invites them to take a survey. This can include a textual prompt such as “Would you like to take a survey?” followed by “Yes” and “No” actuators. In this particular example, the pop-up window also used to provide the customer with a cookie. More specifically, the pop-up window provided to the customer includes a one-by-one pixel image that is associated with at least one name-value pair. The name-value pair includes the ID information corresponding to the customer. Note, the ID information is generated by the customer analysis system.

The ID information is passed to the traffic-monitoring system when the traffic monitoring system acquires the customer's path. That is, the ID information is passed when the traffic-monitoring system is notified that the customer has received the pop-up window. Note, the customer typically already has been provided with a cookie and a corresponding unique (customer) ID when the Web site was first accessed by the customer. This unique ID already should be stored by the traffic-monitoring system and may be used by the traffic-monitoring system to store data associated with that customer. Thus, when the ID information is received, the ID information can be correlated with the customer by using the unique ID.

Cookies can be used by a traffic-monitoring system in a number of manners. For instance, cookies can be used to determine the path that a customer traverses through a Web site. Another cookie can be used to determine whether a customer is to be provided with a survey.

The ID information is enabled to be associated with responses to a survey. In particular, when the customer requests a survey, e.g., completes the survey invitation form indicating a desire to take a survey, the ID information also can be passed to a survey system or other provider that is acquiring information corresponding to the customer responses to the survey. For instance, the ID information can be passed along with other customer information, such as name an email address, that can be used by a survey system to provide the customer with a survey.

By enabling ID information to be associated with both a survey and information corresponding to the use of a Web site by the customer, responses of the customer to the survey can be readily compared to the customer's experience with the Web site. In particular, the customer's path through the various pages of the Web site can be reconstructed and then compared to the survey responses. This enables an analyst to develop an awareness of the pages that the customer viewed so that a context for the survey responses is established.

By using survey systems in accordance with the invention, correlation of information can be accomplished while maintaining a certain degree of confidentiality between entities. This is because confidential customer information need not be used to correlate the information among various entities. In particular, only ID information, which can be arbitrarily assigned, needs to be provided from the customer analysis system to the traffic-monitoring system and/or to the survey system, for example.

Functionality of another embodiment of a survey system in accordance with the invention will now be described with respect to the flowchart of FIG. 3. As depicted in FIG. 3, the functionality (or method) 10 may be construed as beginning at block 310, where a Web site is provided. In block 320, information corresponding to a path through the Web site that was traversed by a customer is acquired. Note, this information can include the path currently being traversed by the customer and/or the path(s) traversed by the customer during previous visits to the Web site. Clearly, the ability to determine the path(s) traversed by a customer during previous visits to a Web site is based at least in part on the duration of the cookie(s) used. Thus, if one or more of the cookies have expired, click-path information may be unable to be retrieved for previous visits.

In block 330, a determination is made as to whether the customer is to be provided with a survey. Thereafter, such as depicted in block 340, ID information is provided to the provider of the survey, e.g., a survey system, if the survey is to be provided to the customer. Likewise, in block 350, the ID information is provided to the provider that is acquiring the information corresponding to the customer's path through the Web site, e.g., a traffic-monitoring system, if the survey is to be provided. Thereafter, such as depicted in block 360, the information corresponding to the path and the information corresponding to the survey is correlated using the ID information. Typically, this is accomplished by a customer analysis system.

Customer analysis systems 100 in accordance with the invention can be implemented in software, firmware, hardware, or a combination thereof. When implemented in hardware, customer analysis system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

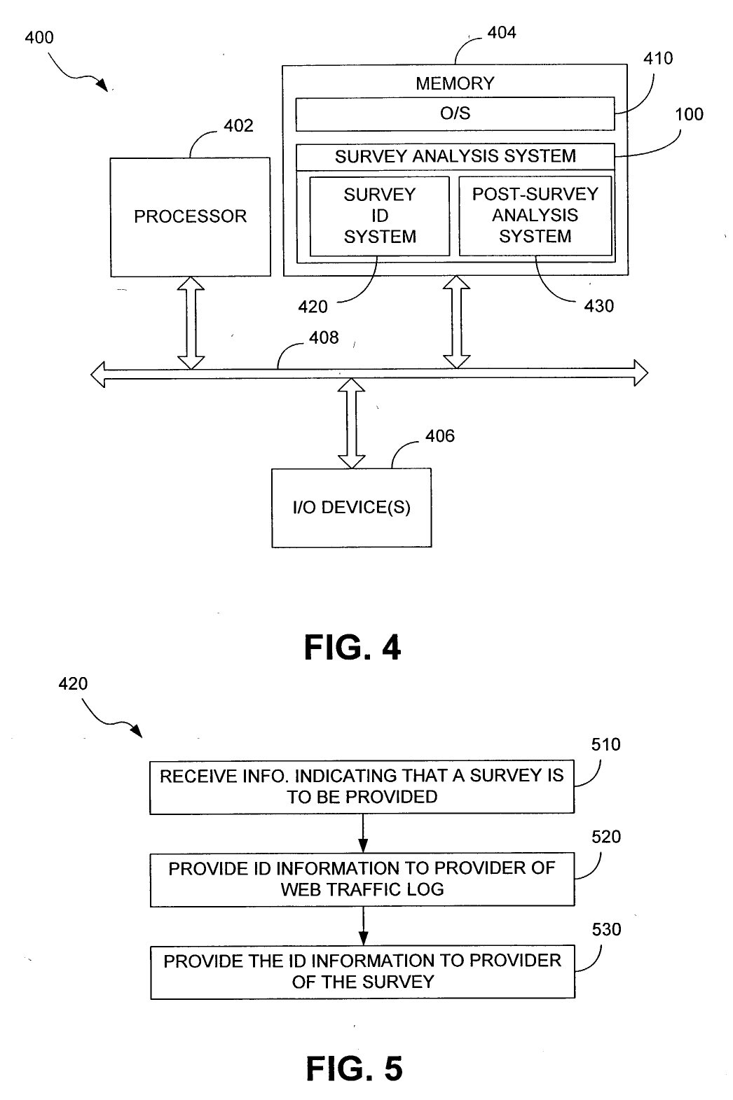

When implemented in software, customer analysis system 100 can be a program that is executable by a digital computer, an example of which is depicted schematically in FIG. 4. Note, computer 400 of FIG. 4 is particularly configured as a printing device, although various other embodiments could merely be adapted to communicate with printing devices.

In FIG. 4, computer 400 includes a processor 402, memory 404, and one or more input and/or output (I/O) devices 406 (or peripherals) that are communicatively coupled via a local interface 408. Processor 402 can be a hardware device configured to execute software that can be stored in memory 404. Memory 404 can include any combination of volatile memory elements and/or nonvolatile memory elements. Moreover, memory 404 can incorporate electronic, magnetic, optical, and/or other types of storage media. Note that memory 404 can have a distributed architecture, where various components are situated remote from one another, but can be accessed by processor 402.

The software in memory 404 can include one or more separate programs, each of which comprises an ordered listing of executable instructions for implementing logical functions. The software in the memory 404 includes customer analysis system 100, which can include a survey ID system 420 and a post-customer analysis system. 430, and an operating system (O/S) 410. The operating system 410 controls the execution of other computer programs, such as customer analysis system.

The I/O device(s) 406 can include input devices such as a keypad and/or a touch screen, for example. I/O device(s) 406 also can include output devices such as a display device or speaker, for example. I/O device(s) 406 may further include devices that are configured to communicate both inputs and outputs such as a communication interface.

When customer analysis system 100 is implemented in software, it should be noted that the customer analysis system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Customer analysis system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable media include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

Reference will now be made to the flowchart of FIG. 5, which depicts the functionality of an embodiment of survey ID system 420 in accordance with the invention. In this regard, each block of the flowchart represents a module segment or portion of code that comprises one or more executable instructions for implementing the specified logical function(s). It should also be noted that in some alternative implementations the functions noted in various blocks of FIG. 5, or any other of the accompanying flowcharts, may occur out of the order in which they are depicted. For example, two blocks shown in succession in FIG. 5 may, in fact, be executed substantially concurrently. In other embodiments, the blocks may sometimes be executed in the reverse order depending upon the functionality involved.

As shown in FIG. 5, the functionality (or method) 420 may be construed as beginning at block 510, where information indicating that a survey is to be provided to a customer is received. In block 520, ID information is provided to the system that is monitoring the customer's path through the Web site, e.g., a traffic-monitoring system. In block 530, the ID information also is provided to the to the provider of the survey, e.g., a survey system.

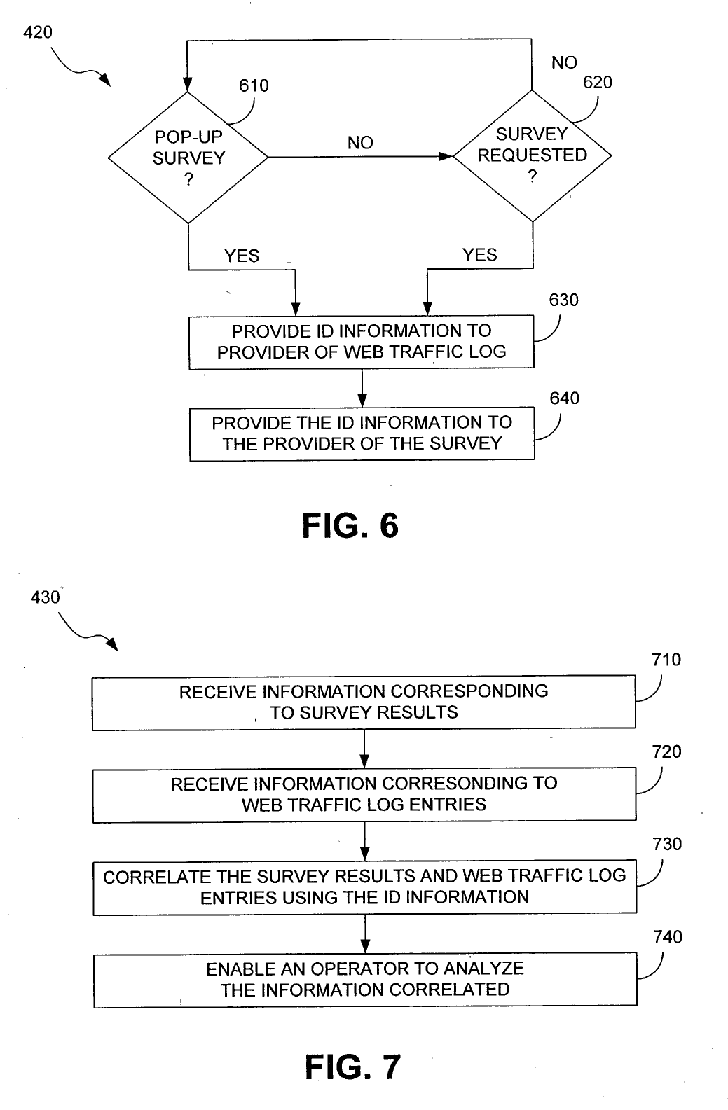

Functionality of another embodiment of survey ID system 426 in accordance with the invention is depicted in FIG. 6. As shown in FIG. 6, the functionality (or method) 420 may be construed as beginning at block 610, where a determination is made as to whether a customer is to be queried regarding taking a customer survey. By way of example, a pop-up survey can be provided to the customer inquiring whether the customer would like to participate in a survey. If it is determined that the customer is not to be queried, the process may proceed to block 620. In block 620, a determination is made as to whether a survey has been requested by the customer. For instance, a customer may actuate a “customer feedback” portion of a Web site. If a survey has not been requested, the process may return to block 610.

If, however, it is determined that a survey is to be provided (block 610) or, alternatively, that the customer has requested a survey (block 620), the process may proceed to block 630. In block 630, ID information is provided to traffic-monitoring system associated with the Web site with which the customer is interacting. Thereafter, such as depicted in block 640, the ID information also is provided to the provider of the survey.

As mentioned before, once ID information has been provided, the ID information can be used to correlate responses of the customer to the survey and the path traversed by the customer through the Web site. In this regard, embodiments of the post-customer analysis system can be used. Functionality of an embodiment of a post-customer analysis system 430 will now be described with respect to the flowchart of FIG. 7.

As shown in FIG. 7, the functionality (or method) 430 may be construed as beginning at block 710, where information corresponding to survey results is received. In block 720, information corresponding to information associated with the customer and corresponding to the path traversed by the customer through a Web site, e.g., web traffic log entries, is received. In block 730, the survey results and web traffic log entries are correlated using the ID information. Note, in other embodiments, other information could be used to correlate the information. Thereafter, such as depicted in block 740, an operator is enabled to analyze the information that was correlated. In particular, in some embodiments, the correlated information can be provided to the user in graphical form such as via a display device.

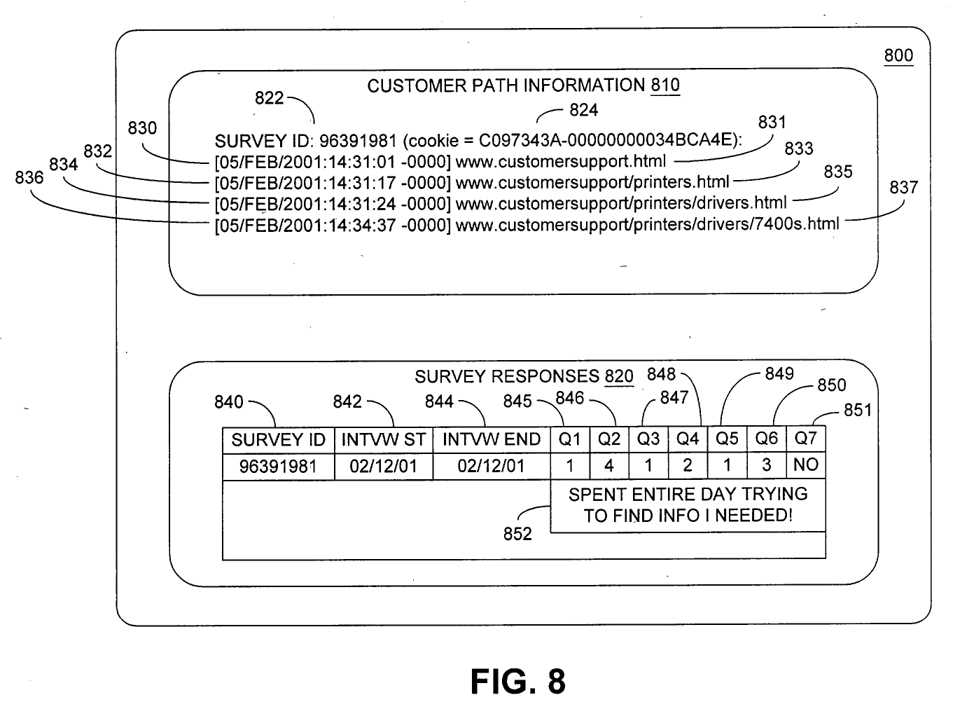

An example of information that can be provided to a user by a post-customer analysis system is depicted schematically in FIG. 8. As shown in FIG. 8, graphical user interface (GUI) 800 includes information 810 corresponding to a path traversed by a customer and information 820 corresponding to the customer's responses to the survey. Information 810 includes a survey ID 822 and the unique (customer) ID 824. Also included is information corresponding to the date/time that a customer accessed a particular page and the particular page that was accessed. For instance, date/time 830 corresponds to the date/time that the customer accessed page 831 (www.customersupport.html), date/time 832 corresponds to page 833 (www.customersupport/printers.html), date/time 834 corresponds to page 835 (www.customersupport/printers/drivers.html), and date/time 836 corresponds to page 837 (www.customersupport/printers/drivers/7400s.html).

Information 820 also includes the survey ID, which is indicated by reference numeral 840, and various other information such as interview start date/time 842, interview end date/time 844, and responses to various questions of the survey that was provided. In FIG. 8, responses to seven questions, e.g., Q1 - Q7, are depicted. Clearly, various types of questions and corresponding types of responses can be used in a survey. For questions 1-6 (845-850), a conventional rating-type question has been asked. For question 7 (851), a yes/no type question has been asked. Additionally, the particular survey responses depicted correspond to a survey that provided the customer with an opportunity to enter textual information. The textual response of the customer is depicted in field 852. In particular, the entry depicted in field 852, i.e., “spent entire day trying to find info I needed!” indicates that the customer experienced particular difficulty in obtaining the information desired. This type of comment makes it particularly useful to identify the customer path that the customer traversed through the Web site so that potential shortcomings in organization of the site can be identified, for example.

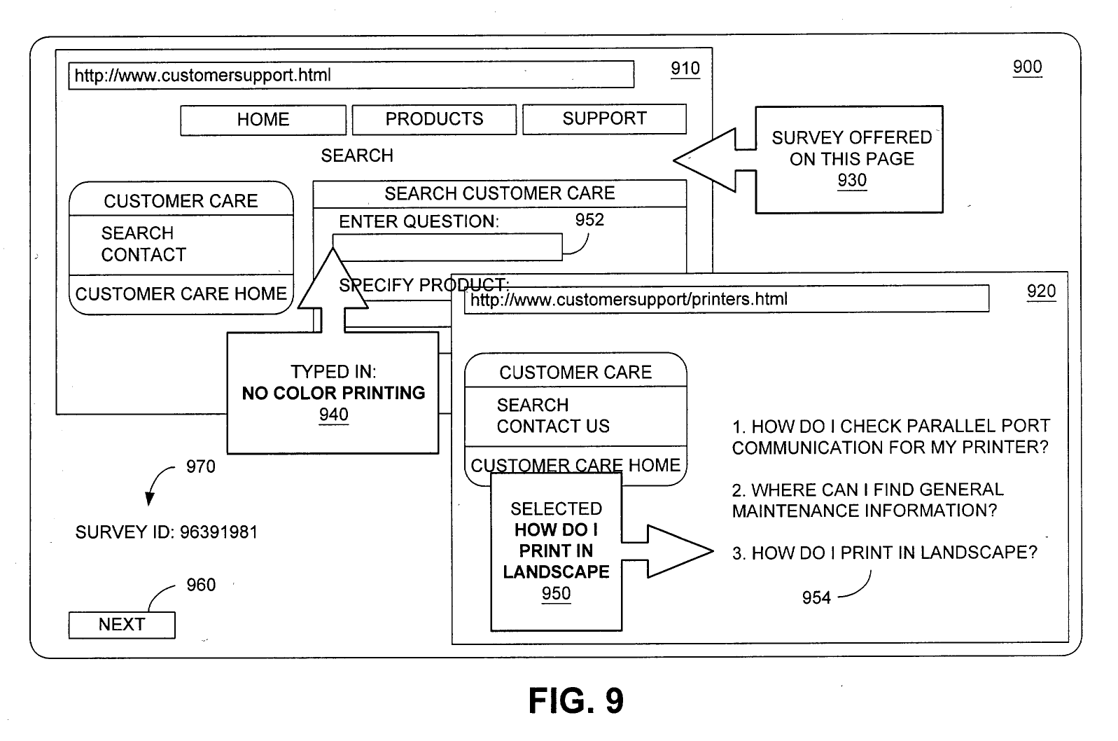

In other embodiments, graphical information corresponding to Web page content also can be displayed to an operator. An example of such an embodiment is depicted schematically in FIG. 9. As shown in FIG. 9, the post-customer analysis system enables graphical information corresponding to the content of Web pages traversed by the customer to be displayed simultaneously with an indication of the particular actions taken by a customer to navigate through the pages. In particular, GUI 900 depicts graphical information corresponding to the first two Web pages traversed by the customer in conjunction with informative messages or notes. More specifically, GUI 900 includes a tile 910 corresponding to page (www.customersupport.html), and a tile 920 corresponding to www.customersupport/printers.html. Notes 930, 940 and 950 also are provided.

With respect to note 930, this note indicates that the customer survey was offered to the customer on the page indicated. Note 940 indicates that when the customer was accessing the (www.customersupport.html) page, the customer typed “no color printing” in the enter question field 952 of the search customer care portion of the page. After entering the information in the search customer care section, the customer was provided with the (www.customersupport/printers.html) page as indicated by tile 920. Thereafter, as indicated by note 950, the customer selected “how do I print in landscape,” which is item 954 of that page.

Clearly, various numbers of pages and notes can be presented by such a GUI. In this particular example, two pages are presented simultaneously. In order to view subsequent pages, an operator can actuate the “next” button 960. In this example, actuation of button 960 enables the GUI 900 to display information associated with the (www.customersupport/printers/drivers.html) page (shown in FIG. 8). Note, other information also can be provided by GUI 900. In FIG. 9, for example, the survey ID is presented in field 970.

It should be emphasized that the above-described embodiments of the present invention are merely possible examples of implementations set forth for a clear understanding of the principles of the invention. Many variations and modifications may be made to the above-described embodiments of the invention without departing substantially from the spirit and principles of the invention. The various systems in FIG. 1 have been described as performing discrete functionality. However, customer analysis systems in accordance with the invention can provide functionality of one or more of the various other systems described herein. For instance, such a customer analysis system could provide the functionality described herein as being provided by the Web service system. All such modifications and variations are intended to be included herein within the scope of this disclosure and the present invention and protected by the following claims.

1. A method for analyzing a customer survey associated with a Web site, said method comprising:
determining whether a user of a Web site is to be provided with a customer survey; and p1 if the user is to be provided with a customer survey;
generating identification information corresponding to the user;
enabling the identification information to be associated with the customer survey; and
enabling the identification information to be associated with information corresponding to a path through the Web site traversed by the user.

2. The method of claim 1, further comprising:
using the identification information to correlate responses of the user to the customer survey with the information corresponding to the path through the Web site traversed by the user.

3. The method of claim 2, further comprising:
providing a graphical representation of the responses correlated with the information corresponding to the path through the Web site traversed by the user.

4. The method of claim 3, wherein providing a graphical representation comprises enabling images corresponding to Web pages of the Web site that the user traversed to be displayed.

5. The method of claim 1, further comprising:
receiving information corresponding to responses of the user to the customer survey and the associated identification information;
receiving the information corresponding to the path through the Web site traversed by the user and the associated identification information; using the identification information to correlate the responses of the user to the customer survey with the information corresponding to the path through the Web site traversed by the user; and
providing a graphical representation of the responses correlated with the information corresponding to the path through the Web site traversed by the user such that at least some of the images corresponding to Web pages of the Web site that the user traversed are enabled to be displayed together with at least some of the responses of the user.

6. A method for analyzing a customer survey associated with a Web site, said method comprising:
providing a Web site;
determining whether a user of the Web site is to be provided with a customer survey;
if the user is to be provided with a customer survey;
generating identification information corresponding to the user; and
enabling the identification information to be associated with the customer survey;
acquiring information corresponding to a path through the Web site traversed by the user;
associating the identification information with information corresponding to the path through the Web site traversed by the user; and
using the identification information to correlate responses of the user to the customer survey with the information corresponding to the path through the Web site traversed by the user.

7. The method of claim 6, further comprising:
providing a graphical representation of the responses correlated with the information corresponding to the path through the Web site traversed by the user.

8. The method of claim 7, wherein providing a graphical representation comprises enabling images corresponding to Web pages of the Web site that the user traversed to be displayed.

9. A computer-readable medium having a computer program for analyzing a customer survey associated with a Web site, said computer-readable medium comprising:
logic configured to determine whether a user of a Web site is to be provided with a customer survey;
logic configured to generate identification information corresponding to the user such that, if the user is to be provided with a customer survey, the identification information is generated;
logic configured to associate the identification information with the customer survey; and
logic configured to associate the identification information with information corresponding to a path through the Web site traversed by the user.

10. The computer-readable medium of claim 9, wherein the logic configured to associate the identification information with information corresponding to a path through the Web site traversed by the user comprises:
logic configured to provide the user with a pop-up window, the pop-up window including an image associated with the identification information.

11. The computer-readable medium of claim 9, wherein the logic configured to determine whether a user of a Web site is to be provided with a customer survey comprises:
logic configured to receive information corresponding to a request from a user to respond to a customer survey.

12. The computer-readable medium of claim 9, further comprising:
logic configured to receive information corresponding to responses of the user to the customer survey and the associated identification information;
logic configured to receive the information corresponding to the path through the Web site traversed by the user and the associated identification information; and
logic configured to use the identification information to correlate the responses of the user to the customer survey with the information corresponding to the path through the Web site traversed by the user.

13. The computer-readable medium of claim 9, further comprising:
logic configured to provide a graphical representation of the responses correlated with the information corresponding to the path through the Web site traversed by the user such that at least some of the images corresponding to Web pages of the Web site that the user traversed are enabled to be displayed together with at least some of the responses of the user.

14. The computer-readable medium of claim 9, further comprising:
logic configured to provide the user with the customer survey.

15. The computer-readable medium of claim 9, further comprising:
logic configured to determine the path through the Web site traversed by the user.

16. A computer-readable medium having a computer program for analyzing a customer survey associated with a Web site, said computer-readable medium comprising:
logic configured to receive information corresponding to a path through the Web site traversed by the user;
logic configured to receive responses of the user to the customer survey;
logic configured to provide a graphical representation of the responses correlated with the information corresponding to the path through the Web site traversed by the user such that such that images corresponding to at least some of the Web pages of the Web site that the user traversed are enabled to be displayed together with at least some of the responses of the user.

17. The computer-readable medium of claim 16, wherein the logic configured to provide a graphical representation comprises logic configured to annotate the images with information corresponding to interaction of the user with the Web site.

18. A system for analyzing a customer survey associated with a Web site, said system comprising:
a customer analysis system operative to determine whether a user of a Web site is to be provided with a customer survey and to generate identification information corresponding to the user such that, if the user is to be provided with a customer survey, the identification information is generated, and is enabled to be associated with the customer survey and information corresponding to a path through the Web site traversed by the user.

19. The system of claim 18, further comprising:
a traffic-monitoring system communicating with the customer analysis system, the traffic-monitoring system being operative to determine the path through the Web site traversed by the user, receive the identification information, associate the identification information with the path, and communicate the path to the customer analysis system.

20. The system of claim 19, wherein, if the user is to be provided with a customer survey, the customer analysis system is operative to provide the identification information to the traffic-monitoring system automatically.

21. The system of claim 18, further comprising:
a survey system communicating with the customer analysis system, the survey system being operative to provide the user with the customer survey, receive responses of the user to the customer survey, receive the identification information, associate the identification information with the responses, and communicate the responses to the customer analysis system.

22. The system of claim 21, wherein, if the user is to be provided with a customer survey, the customer analysis system is operative to provide the identification information to the survey system automatically.

23. The system of claim 18, further comprising:
a Web service system communicating with the customer analysis system, the Web service system being operative to provide the Web site and determine whether the user is to be provided with a customer survey such that, if the customer is to be provided with a customer survey, the Web service system notifies the customer analysis system that the customer is to be provided with a customer survey.

24. The system of claim 18, wherein the customer analysis system comprises:
means for correlating the responses of the user to the customer survey with the information corresponding to the path through the Web site traversed by the user.

25. The system of claim 18, wherein the customer analysis system is operative to receive information corresponding to responses of the user to the customer survey, receive the information corresponding to the path through the Web site traversed by the user, and use the identification information to correlate the responses of the user to the customer survey with the information corresponding to the path through the Web site traversed by the user.

26. The system of claim 25, wherein the customer analysis system is operative to provide a graphical representation of the responses correlated with the information corresponding to the path through the Web site traversed by the user such that at least some of the images corresponding to Web pages of the Web site that the user traversed are enabled to be displayed together with at least some of the responses of the user.
